(19) United States
(12) Patent Application Publication
(10) Pub. No.: US 2025/0277977 A1
(43) Pub. Date: Sep. 4, 2025

(54) Triggered Dimming and Undimming of a Head-Mountable Device

(71) Applicant: Apple Inc., Cupertino, CA (US)

(72) Inventors: Anshu K. Chimalamarri, Sunnyvale, CA (US); Brad K. Herman, Culver City, CA (US); Jonathan C. Moisant-Thompson, San Jose, CA (US); Manuel C. Clement, Felton, CA (US)

(21) Appl. No.: 18/669,504

(22) Filed: May 20, 2024

Related U.S. Application Data
(60) Provisional application No. 63/471,807, filed on Jun. 8, 2023.

(51) Int. Cl. G02B 27/01; G09G 3/00; G09G 3/20

(52) U.S. Cl. CPC G02B 27/0172; G09G 3/001; G09G 3/2096; G02B 2027/014; G09G 2320/0626; G09G 2354/00

(57) ABSTRACT

In one implementation, a method of setting a dimming value of a display is performed by a device including an at least partially transparent display including a dimming layer, one or more processors, and non-transitory memory. The method includes detecting that a user is engaged in conversation with a conversation partner. The method includes determining a dimming amount based at least in part on detecting that the user is engaged in conversation with the conversation partner. The method includes setting a dimming value of at least a portion of the dimming layer to the dimming amount.

### CROSS-REFERENCE TO RELATED APPLICATIONS

This application claims priority to U.S. Provisional Patent App. No. 63/471,807, filed on Jun. 8, 2023, which is hereby incorporated by reference in its entirety.

### TECHNICAL FIELD

The present disclosure generally relates to systems, methods, and devices for controlling the dimming level of a head-mountable device (HMD).

### BACKGROUND

In various implementations, a head-mounted device (HMD) can include an optical passthrough display which is at least partially transparent. In various implementations, the optical passthrough display includes a display layer that emits light or reflects light projected from a light source according to display data and dimming layer that dims light passing through the optical passthrough display according to dimming data. By controlling the dimming data, the HMD can be operated as “smart sunglasses” that automatically dim according to ambient light levels.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1A is a block diagram of an example operating architecture in accordance with some implementations.

FIG. 1B is a perspective view of a XR environment in accordance with some implementations.

FIGS. 2A-2C illustrate a first XR environment during a series of time periods in accordance with some implementations.

FIGS. 3A-3E illustrate a second XR environment during a series of time periods in accordance with some implementations.

FIG. 4 is a flowchart representation of a method of setting a dimming value of a display in accordance with some implementations.

FIG. 5 is a flowchart representation of another method of setting a dimming value of a display in accordance with some implementations.

FIG. 6 is a block diagram of an example controller in accordance with some implementations.

FIG. 7 is a block diagram of an example electronic device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and a method for setting a dimming value of a display. In various implementations, the method is performed by a device including an at least partially transparent display including a dimming layer, one or more processors, and non-transitory memory. The method includes detecting that a user is engaged in conversation with a conversation partner. The method includes determining a dimming amount based at least in part on detecting that the user is engaged in conversation with the conversation partner. The method includes setting a dimming value of at least a portion of the dimming layer to the dimming amount.

Various implementations disclosed herein include devices, systems, and a method for setting a dimming value of a display. In various implementations, the method is performed by a device including an at least partially transparent display including a dimming layer, one or more processors, and non-transitory memory. The method includes detecting that a user is engaged in conversation with a conversation partner. The method includes displaying, on the display, virtual content at a display location. The method includes, in response to detecting that the user is engaged in conversation with the conversation partner, increasing a dimming value of the dimming layer in a region surrounding and including the display location.

In accordance with some implementations, a device includes one or more processors, a non-transitory memory, and one or more programs; the one or more programs are stored in the non-transitory memory and configured to be executed by the one or more processors. The one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices, and circuits have not been described in exhaustive detail so as not to obscure more pertinent aspects of the example implementations described herein.

Some HMDs can operate as “smart sunglasses” by controlling the operation of a dimming layer of an optical passthrough display. For example, when a user is indoors (in low-light conditions), a dimming level of the dimming layer is set to a low value allowing more light to pass through, but when the user is outdoors (in bright-light conditions), the dimming level is set to a high value allowing less light to pass through. However, controlling the dimming level based only on the current ambient light level may lead to undesirable results in certain social situations. For example, it may be considered rude to shade one's eyes while engaged in conversation. Whereas removing sunglasses is relatively simple, adjusting the dimming level of a dimming layer of an optical passthrough display of an HMD may be input-intensive. Accordingly, in various implementations, the dimming level is automatically adjusted according to various factors, such as whether the user is engaged in conversation with a conversation partner, whether the user is indoors or outdoors, the location of light sources with respect to the user, and user preferences.

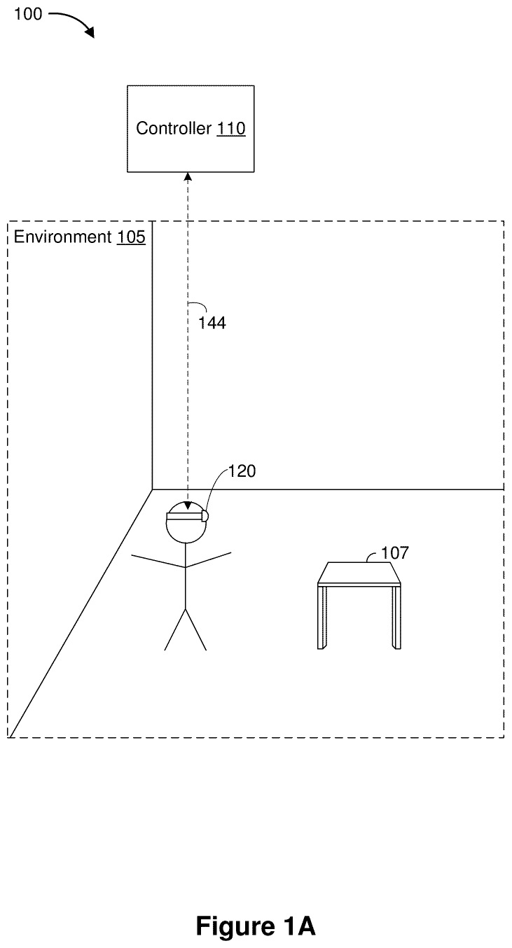

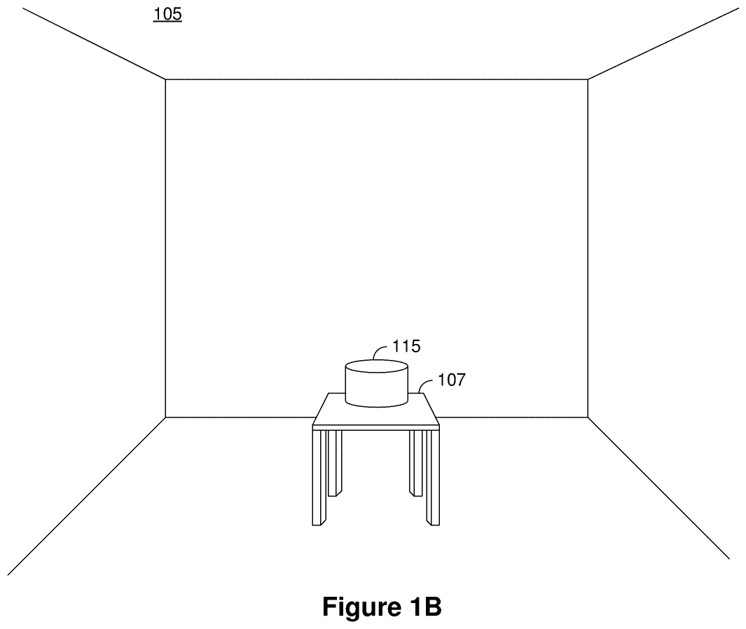

FIG. 1A is a block diagram of an example operating architecture 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating architecture 100 includes a controller 110 and a head-mounted device (HMD) 120 within a physical environment 105 including a table 107.

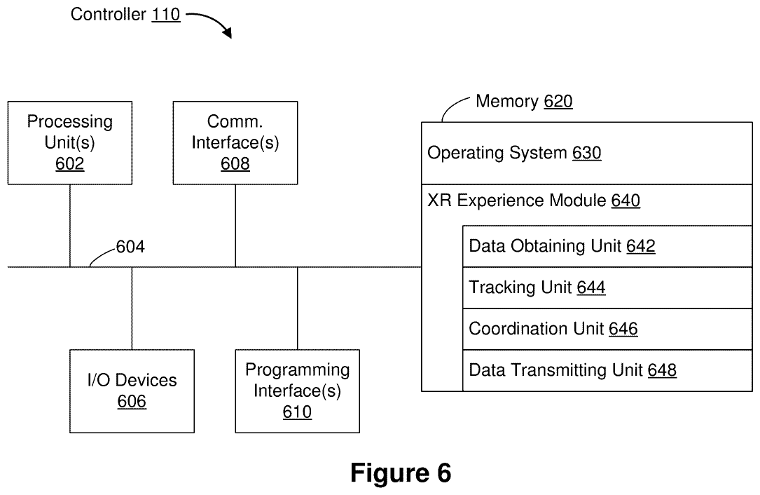

In some implementations, the controller 110 is configured to manage and coordinate an XR experience for the user. In some implementations, the controller 110 includes a suitable combination of software, firmware, and/or hardware. The controller 110 is described in greater detail below with respect to FIG. 6. In some implementations, the controller 110 is a computing device that is local or remote relative to the physical environment 105. For example, the controller 110 is a local server located within the physical environment 105. In another example, the controller 110 is a remote server located outside of the physical environment 105 (e.g., a cloud server, central server, etc.). In some implementations, the controller 110 is communicatively coupled with the HMD 120 via one or more wired or wireless communication channels 144 (e.g., BLUETOOTH, IEEE 802.11x, IEEE 802.16x, IEEE 802.3x, etc.). In another example, the controller 110 is included within the enclosure of the HMD 120.

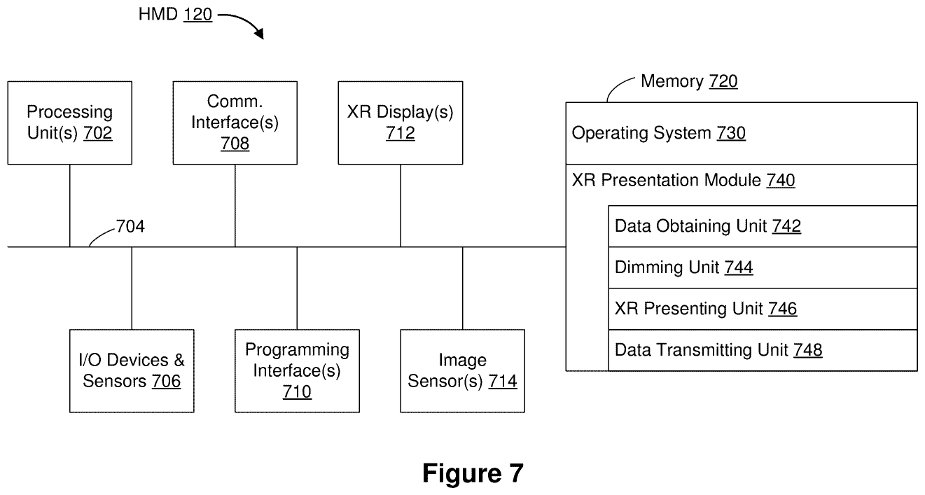

According to some implementations, the HMD 120 provides an XR experience to the user while the user is virtually and/or physically present within the physical environment 105. For example, FIG. 1B illustrates the physical environment 105 from the perspective of the user in which the table 107 is visible with a virtual object 115 (displayed by the HMD 120) upon the table 107. In some implementations, the HMD 120 includes a suitable combination of software, firmware, and/or hardware. The HMD 120 is described in greater detail below with respect to FIG. 7. In some implementations, the functionalities of the controller 110 are provided by and/or combined with the HMD 120.

In some implementations, the user wears the HMD 120 on his/her head. As such, the HMD 120 includes one or more XR displays provided to display the XR content. For example, in various implementations, the HMD 120 encloses the field-of-view of the user. In some implementations, the HMD 120 is replaced with a handheld device (such as a smartphone or tablet) configured to present XR content, and rather than wearing the HMD 120 the user holds the device with a display directed towards the field-of-view of the user and a camera directed towards the physical environment 105. In some implementations, the handheld device can be placed within an enclosure that can be worn on the head of the user. In some implementations, the HMD 120 is replaced with a XR chamber, enclosure, or room configured to present XR content in which the user does not wear or hold the HMD 120.

In various implementations, the one or more XR displays are optical passthrough displays that are at least partially transparent. In various implementations, an optical passthrough display includes a display layer that emits light or reflects light projected from a light source according to display data. In various implementations, the display data is an image including a matrix of pixels having respective pixel values indicative of an amount of light emitted or projected at each pixel location. In various implementations, the pixel values are color triplets indicative of an amount of light of each of three colors emitted or projected at each pixel location.

In various implementations, an optical passthrough display includes a dimming layer that dims light passing through the optical passthrough display according to dimming data. In various implementations, the dimming data is a single dimming value indicating an amount of dimming applied to light passing through any location of the optical passthrough display. In various implementations, the dimming value is binary, e.g., either 0 (indicating that no dimming is applied) or 1 (indicating that full dimming is applied). In various implementations, light passing through the optical passthrough display is fully dimmed so much as to be referred to as blocked or occluded. In various implementations, the dimming value is non-binary. For example, in various implementations, the dimming value takes any of a range of values between 0 and 1. The range of values may be continuous or discrete.

In various implementations, the dimming data includes a plurality of dimming values for a respective plurality of regions of the optical passthrough display. In various implementations, the dimming data includes a matrix of pixels having respective dimming values indicative of an amount of dimming applied light passing through the optical passthrough display at each pixel location. In various implementations, the dimming values are binary or non-binary. In various implementations, the dimming values are continuous or discrete. In various implementations, using binary dimming values in an appropriate pattern (e.g., a checkerboard pattern), regions of the optical passthrough display can be partially dimmed to a level between fully dimmed and undimmed.

In various implementations, when a user wears the HMD 120, the display layer is closer to the user's eyes than the dimming layer. In various implementations, the HMD 120 is a pair of smart glasses that includes smart lenses with a dimming layer, but no display layer.

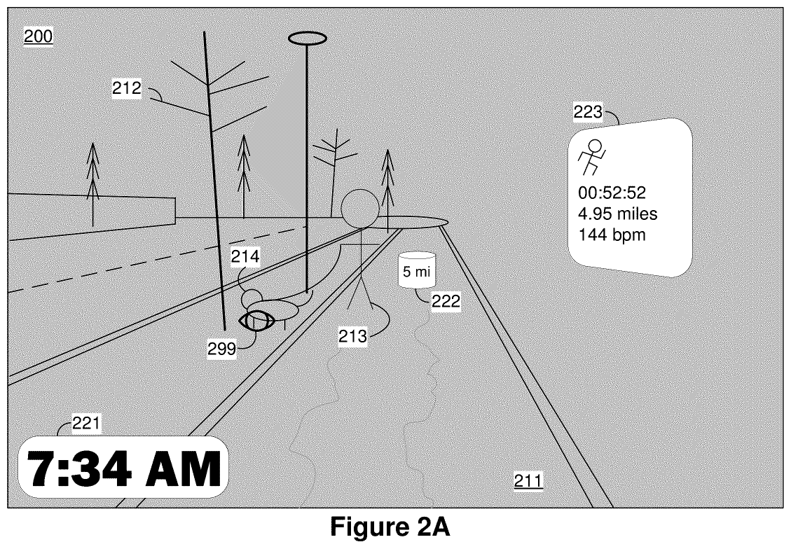

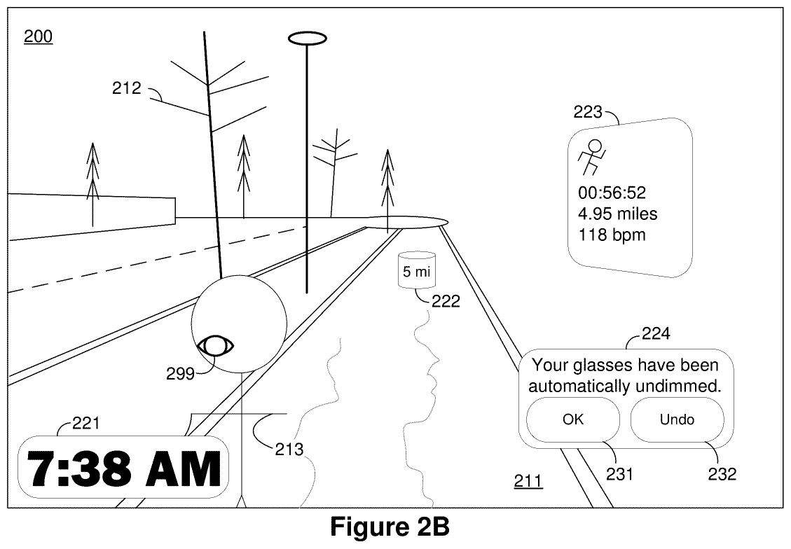

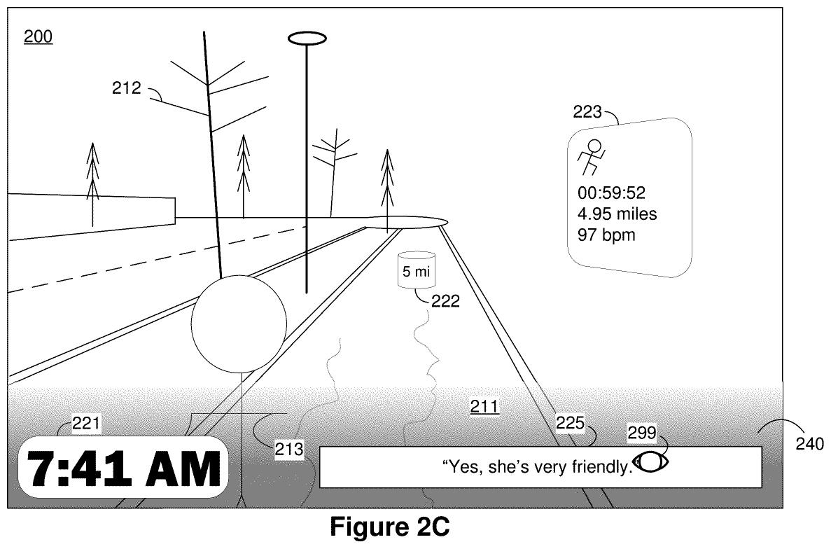

FIGS. 2A-2C illustrate a first XR environment 200 presented, at least in part, by a display of an electronic device, such as the HMD 120 of FIG. 1. The first XR environment 200 is based on a physical environment of a street at which the electronic device is present. FIGS. 2A-2C illustrate the first XR environment 200 during a series of time periods. In various implementations, each time period is an instant, a fraction of a second, a few seconds, a few hours, a few days, or any length of time.

FIGS. 2A-2C illustrate a gaze location indicator 299 that indicates a gaze location of the user, e.g., where in the first XR environment 200 the user is looking. Although the gaze location indicator 299 is illustrated in FIGS. 2A-2C, in various implementations, the gaze location indicator 299 is not displayed by the electronic device.

FIG. 2A illustrates the first XR environment 200 during a first time period. The first XR environment 200 includes a plurality of objects, including one or more physical objects (e.g., a sidewalk 211, a tree 212, a person 213, and a dog 214) of the physical environment and one or more virtual objects (e.g., a virtual clock 221, a virtual mile marker 222, and a virtual running application window 223). In various implementations, certain objects (such as the physical objects and the virtual mile marker 222) are presented at a location in the first XR environment 200, e.g., at a location defined by three coordinates in a three-dimensional (3D) XR coordinate system such that while some objects may exist in the physical world and the others may not, a spatial relationship (e.g., distance or orientation) may be defined between them. Accordingly, when the electronic device moves in the first XR environment 200 (e.g., changes either position and/or orientation), the objects are moved on the display of the electronic device, but retain their location in the first XR environment 200. Such virtual objects that, in response to motion of the electronic device, move on the display, but retain their position in the first XR environment 200 are referred to as world-locked objects.

In various implementations, certain virtual objects (such as the virtual clock 221) are displayed at locations on the display such that when the electronic device moves in the first XR environment 200, the objects are stationary on the display on the electronic device. Such virtual objects that, in response to motion of the electronic device, retain their location on the display are referred to as display-locked objects.

In various implementations, the location in the first XR environment 200 of certain virtual objects (such as the virtual running application window 223) changes based on the pose of the body of the user. Such virtual objects are referred to as body-locked objects. For example, as the user runs, the virtual running application window 223 maintains a location approximately one meter in front and half a meter to the left of the user (e.g., relative to the position and orientation of the user's torso). As the head of the user moves, without the body of the user moving, the virtual running application window 223 appears at a fixed location in the first XR environment 200.

During the first time period, a dimming value of the display (or a dimming layer thereof) is set to one-half. Further, during the first time period, as indicated by the gaze location indicator 299, the user is looking at the dog 214.

FIG. 2B illustrates the first XR environment 200 during a second time period subsequent to the first time period. During the second time period, as indicated by the gaze location indicator 299, the user is looking at the person 213. Based on this gaze information and, in various implementations, other factors (such as audio of the user and/or the person 213 talking), the electronic device determines that the user is engaged in conversation with the person 213.

While the user engages in conversation with the person 213, the person 213 may find it rude or offensive for the user to shade the user's eyes (e.g., by wearing dark glasses or an HMD with a high dimming value). The person 213 may think that the user is aloof or trying to hide something. Thus, in response to detecting that the user is engaged in conversation with the person 213, the dimming value of the display is set to zero. In response to setting the dimming value of the display to zero, the electronic device may display a dimming notification 224 indicating that the dimming value of the display has been automatically changed (e.g., based on determining that the user is engaged in conversation with the person 213). In various implementations, the dimming notification 224 is a display-locked virtual object.

The dimming notification 224 may include a confirm affordance 231 which, when selected, causes the electronic device to cease displaying the dimming notification 224. The dimming notification 224 may further include a deny affordance 232 which, when selected, causes the electronic device to cease displaying the dimming notification 224 as reset of the dimming value of the display back to its previous value (e.g., a dimming value of one-half). Further, user selection of the confirm affordance 231 or the deny affordance 232 may provide feedback to the electronic device regarding the user's preferences for future automatic setting of the dimming value. In various implementations, the electronic device ceases to display the dimming notification 224 if a threshold amount of time has passed without selection of either the confirm affordance 231 or the deny affordance 232. This also provides feedback regarding the user's preferences for future automatic setting of the dimming value.

FIG. 2C illustrates the first XR environment 200 during a third time period subsequent to the second time period. During the third time period, the electronic device displays a transcription 225 of a portion of the conversation spoken by the person 213. In various implementations, the transcription 225 is a display-locked virtual object.

During the third time period, as indicated by the gaze indicator 299, the user is looking at the transcription 225. In various circumstances, the person 213 may misinterpret the aversion of the user's gaze from the person 213. For example, the person 213 may believe that the person is uninterested in the conversation or interested in a real object behind the transcription 225. Accordingly, in various implementations, the electronic device increases the dimming value of at least the region of the display including the transcription 225. For example, in FIG. 2C, the region 240 at the bottom of the display has a dimming value of one-half. In various implementations, the dimming is feathered such that the dimming value of pixels within a region adjacent to the region 240 decrease as a function of distance from the region 240.

In various implementations, the electronic device increases the dimming value of the region 240 in response to displaying virtual content. For example, in various implementations, the electronic device increases the dimming value of the region 240 in response to displaying the transcription 225. In various implementations, the electronic device increases the dimming value of the region 240 in response to determining that the user is looking at the region 240 and/or virtual content within the region 240. For example, in various implementations, the electronic device increases the dimming value of the region 240 in response to determining that the user is looking at the transcription 225. As another example, in various implementations, when the gaze of the user is directed to the virtual clock 221, the region 240 is dimmed.

By dimming the region 240, the electronic device provides a cue to the person 213 that the user's gaze is averted due to the presentation (and consumption) of virtual content rather than for other reasons. Further, dimming the region 240 provides enhanced contrast for the virtual content, making the virtual content easier for the user to consume.

Whereas the transcription 225 is shown at a region 240 at the bottom of the display in FIG. 2C, various types of virtual content may be displayed in various portions of the display and may trigger dimming. In various implementations, the virtual content is based on the conversation. For example, in various implementations, the virtual content includes the transcription 225 of the conversation or a translation of the conversation. In various implementations, the virtual content includes a notification. For example, in various implementations, the notification indicates a received text message, incoming phone call, alarm, or reminder. In various implementations the region 240 is at a top, bottom, left, right, or middle of the display.

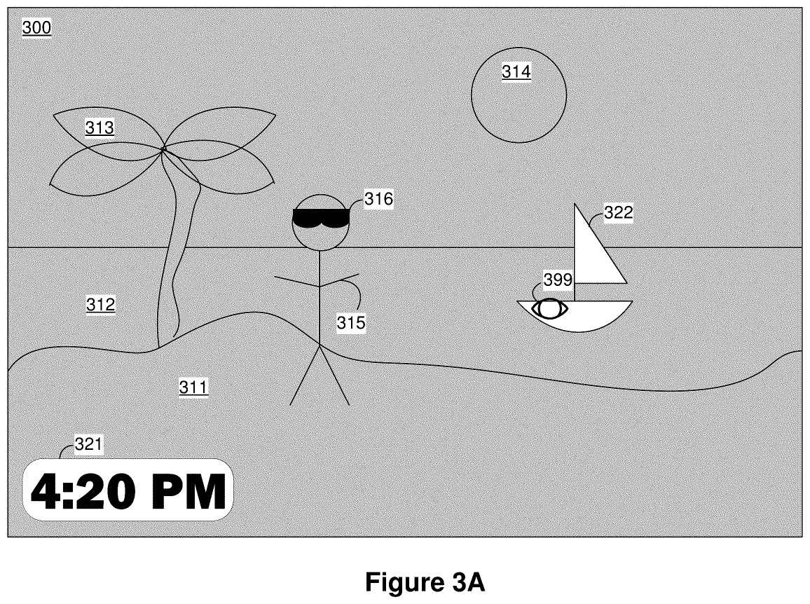

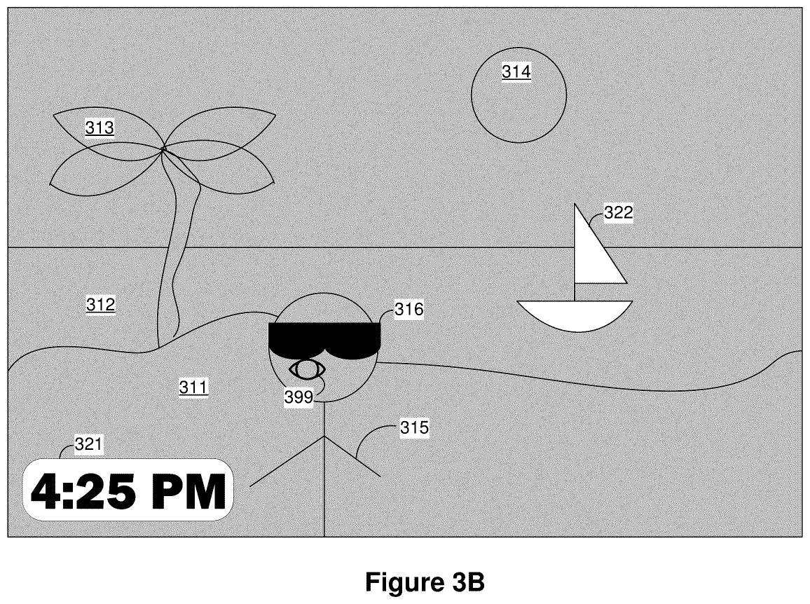

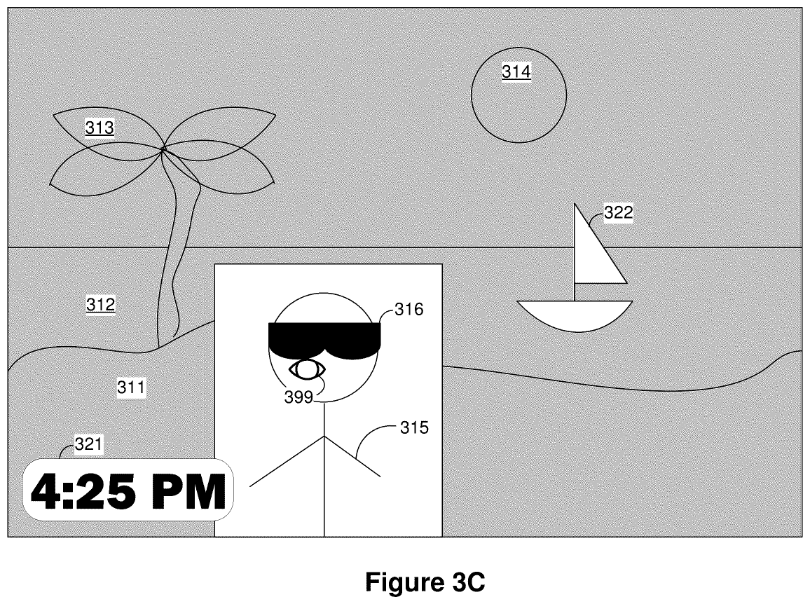

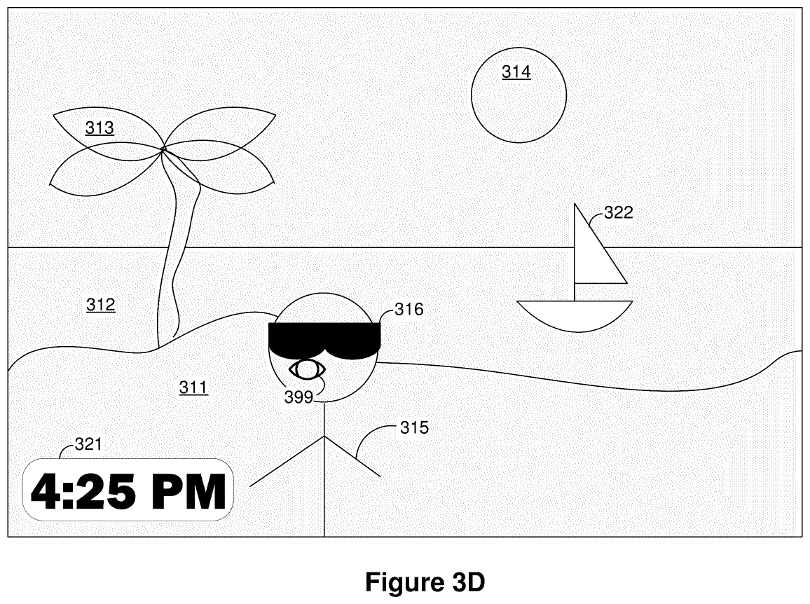

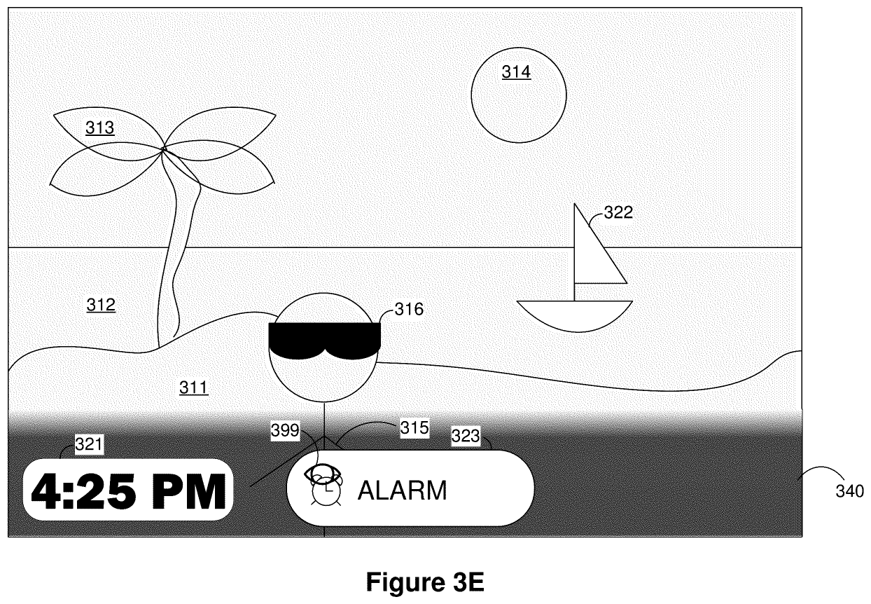

FIGS. 3A-3E illustrate a second XR environment 300 presented, at least in part, by a display of an electronic device, such as the HMD 120 of FIG. 1. The second XR environment 300 is based on a physical environment of a beach at which the electronic device is present. FIGS. 3A-3E illustrate the second XR environment 300 during a series of time periods. In various implementations, each time period is an instant, a fraction of a second, a few seconds, a few hours, a few days, or any length of time.

FIGS. 3A-3E illustrate a gaze location indicator 399 that indicates a gaze location of the user, e.g., where in the second XR environment 300 the user is looking. Although the gaze location indicator 399 is illustrated in FIGS. 3A-3E, in various implementations, the gaze location indicator 399 is not displayed by the electronic device.

FIG. 3A illustrates the second XR environment 300 during a first time period. The second XR environment 300 includes a plurality of objects, including one or more physical objects (e.g., sand 311, water 312, a tree 313, the sun 314, a person 315, and sunglasses 316) of the physical environment and one or more virtual objects (e.g., a virtual clock 321 and a virtual boat 322). In various implementations, certain objects (such as the physical objects and the virtual boat marker 322) are presented at a location in the second XR environment 300, e.g., at a location defined by three coordinates in a three-dimensional (3D) XR coordinate system such that while some objects may exist in the physical world and the others may not, a spatial relationship (e.g., distance or orientation) may be defined between them. Accordingly, when the electronic device moves in the second XR environment 300 (e.g., changes either position and/or orientation), the objects are moved on the display of the electronic device, but retain their location in the second XR environment 300.

In various implementations, certain virtual objects (such as the virtual clock 321) are displayed at locations on the display such that when the electronic device moves in the second XR environment 300, the objects are stationary on the display on the electronic device.

During the first time period, a dimming value of the display (or a dimming layer thereof) is set to one-half. Further, during the first time period, as indicated by the gaze location indicator 399, the user is looking at the virtual boat 322.

FIG. 3B illustrates the second XR environment 300 during a second time period subsequent to the first time period in accordance with a first embodiment. During the second time period, as indicated by the gaze location indicator 399, the user is looking at the person 315. Based on this gaze information and, in various implementations, other factors (such as audio of the user and/or the person 315 talking), the electronic device determines that the user is engaged in conversation with the person 315.

Whereas, in FIG. 2B, when the electronic device undims the display in response to determining that the user is engaged in conversation with the person 213, in FIG. 3B, in response to determining that the user is engaged in conversation with the person 315, the electronic device does not undim the display. In various implementations, the electronic device uses multiple factors to determine the dimming value of the display. For example, in FIG. 3B, although the electronic device determines that the user is engaged in conversation with the person 315, the electronic device further determines that the electronic device is outdoors, that a strong light source (e.g., the sun 314) is in front of the user, and that the person 315 is also shading their eyes (e.g., wearing the sunglasses 316). Based on at least one of these factors and, in some implementations, user preferences regarding a weighting of these factors, the electronic device determines that the dimming value should be set at an unchanged dimming value of one-half.

FIG. 3C illustrates the second XR environment 300 during the second time period in accordance with a second embodiment. As noted above, during the second time period, the user is looking at the person 315 and the electronic device determines that the user is engaged in conversation with the person 315.

Whereas, in FIG. 2B, when the electronic device undims the entire display in response to determining that the user is engaged in conversation with the person 213, in FIG. 3C, in response to determining that the user is engaged in conversation with the person 315, the electronic device undims only a portion of the display surrounding the person 315. In various implementations, the electronic device uses multiple factors to determine the dimming value of the remainder of the display. For example, in FIG. 3C, although the electronic device determines that the user is engaged in conversation with the person 315, the electronic device further determines that the electronic device is outdoors, that a strong light source (e.g., the sun 314) is in front of the user, and that the person 315 is also shading their eyes (e.g., wearing the sunglasses 316). Based on at least one of these factors and, in some implementations, user preferences regarding a weighting of these factors, the electronic device determines that the dimming value of the portion of the display surrounding the person 315 should be set to zero and the dimming value of the remainder of the display should be set at an unchanged dimming value of one-half.

FIG. 3D illustrates the second XR environment 300 during the second time period in accordance with a third embodiment. As noted above, during the second time period, the user is looking at the person 315 and the electronic device determines that the user is engaged in conversation with the person 315.

Whereas, in FIG. 2B, when the electronic device completely undims the display in response to determining that the user is engaged in conversation with the person 213, in FIG. 3C, in response to determining that the user is engaged in conversation with the person 315, the electronic device partially undims the display. In various implementations, the electronic device uses multiple factors to determine the dimming value of the display. For example, in FIG. 3D, although the electronic device determines that the user is engaged in conversation with the person 315, the electronic device further determines that the electronic device is outdoors, that a strong light source (e.g., the sun 314) is in front of the user, and that the person 315 is also shading their eyes (e.g., wearing the sunglasses 316). Based on at least one of these factors and, in some implementations, user preferences regarding a weighting of these factors, the electronic device determines that the dimming value of the display should be set at a reduced dimming value of one-quarter.

FIG. 3E illustrates the second XR environment 300 during a third time period subsequent to the second time period. During the third time period, the electronic device displays an alarm notification 323. In various implementations, the alarm notification 323 is a display-locked virtual object.

During the third time period, as indicated by the gaze indicator 399, the user is looking at the alarm notification 323. In various circumstances, the person 315 may misinterpret the aversion of the user's gaze from the person 315. For example, the person 315 may believe that the person is uninterested in the conversation or interested in a real object behind the alarm notification 323 (e.g., a portion of the body of the person 315 other than the face of the person 315). Accordingly, in various implementations, the electronic device increases the dimming value of at least the region of the display including the alarm notification 323. For example, in FIG. 3E, the region 340 at the bottom of the display has a dimming value of three-quarters. In various implementations, the dimming is feathered such that the dimming value of pixels within a region adjacent to the region 340 decreases as a function of distance from the region 340.

In various implementations, the electronic device increases the dimming value of the region 340 in response to displaying virtual content. For example, in various implementations, the electronic device increases the dimming value of the region 340 in response to displaying the alarm notification 323. In various implementations, the electronic device increases the dimming value of the region 340 in response to determining that the user is looking at the region 340 and/or virtual content within the region 340. For example, in various implementations, the electronic device increases the dimming value of the region 340 in response to determining that the user is looking at the alarm notification 323. As another example, in various implementations, when the gaze of the user is directed to the virtual clock 321, the region 340 is dimmed.

By dimming the region 340, the electronic device provides a cue to the person 315 that the user's gaze is averted due to the presentation (and consumption) of virtual content rather than for other reasons. Further, dimming the region 340 provides enhanced contrast for the virtual content, making the virtual content easier for the user to consume.

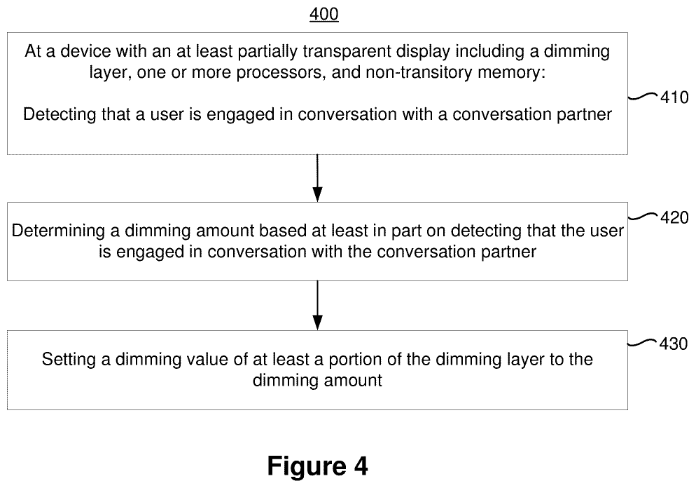

FIG. 4 is a flowchart representation of a method of setting a dimming value of a display in accordance with some implementations. In various implementations, the method 400 is performed by a device including an at least partially transparent display including a dimming layer, one or more processors and non-transitory memory (e.g., the HMD 120 of FIG. 1). In some implementations, the method 400 is performed by processing logic, including hardware, firmware, software, or a combination thereof. In some implementations, the method 400 is performed by a processor executing instructions (e.g., code) stored in a non-transitory computer-readable medium (e.g., a memory).

The method 400 begins, in block 410, with the device detecting that a user is engaged in conversation with a conversation partner. In various implementations, the device detects that the user is engaged in conversation with the conversation partner using input from various sensors of the device, such as a microphone, an image sensor, and an eye tracker. For example, in various implementations, the device detects that the user is engaged in conversation with the conversation partner based on speech detected by the microphone from the user to the conversation partner and/or from the conversation partner to the user. In various implementations, the device detects that the user is engaged in conversation with the conversation partner based on detecting the conversation partner in an image captured with the image sensor and based on detecting that the user is looking at the conversation partner based on eye tracking data from the eye tracker. In various implementations, the device detects that the user is engaged in conversation based on an amount of time that speech and/or gaze being directed towards the conversation partner is detected, thereby discriminating between a conversation and a brief message (e.g., “Excuse me.”).

In various implementations, the device determines, based on the data from the sensors, a confidence score indicative of a likelihood that the user is engaged in conversation with the conversation partner. In various implementations, the device detects that the user is engaged in conversation with the conversation partner when the confidence score is greater than a threshold score.

The method 400 continues, in block 420, with the device determining a dimming amount based at least in part on detecting that the user is engaged in conversation with the conversation partner. In various implementations, determining the dimming amount includes determining a dimming amount of zero in response to detecting that the user is engaged in conversation with the conversation partner. For example, in FIG. 2B, the dimming value of the display is set to zero in response to detecting that the user is engaged in conversation with the person 213.

As partially described above, in various implementations, the dimming amount is based on a number of factors in addition to detecting that the user is engaged in conversation with a conversation partner. The factors may be determined using data from various sensors, including an ambient light sensor, a location sensor (e.g., a GPS sensor), an image sensor, an eye tracker, and a motion sensor. For example, using an ambient light sensor, the device determines a level of ambient light. When the ambient light level is high, the dimming value is higher or less likely to be reduced in response to detecting that the user is engaged in conversation with the conversation partner. For example, using a location sensor (and/or an image sensor), the device determines whether the user is indoors or outdoors. When the user is indoors, the dimming value is lower or more likely to be reduced in response to detecting that the user is engaged in conversation with the conversation partner. As another example, using the image sensor, the device determines the location of strong light sources. When the user is facing a strong light source, the dimming value is higher or less likely to be reduced in response to detecting that the user is engaged in conversation with the conversation partner. As another example, using the image sensor, the device determines an identity of the conversation partner. When the user is engaged in conversation with different conversation partners, the dimming value or the likelihood that the dimming value is reduced may be different. As another example, using the image sensor, the device determines whether the conversation partner is shading their eyes. When the conversation partner is shading their eyes (e.g., wearing sunglasses or a dimmed HMD), the dimming value is higher or less likely to be reduced in response to detecting that the user is engaged in conversation with the conversation partner. As another example, using an eye tracker, the device determines whether the user is looking at the conversation partner. When the user is not looking at the conversation partner (e.g., having a conversation while hiking along a trail), the dimming value is higher or less likely to be reduced in response to detecting that the user is engaged in conversation with the conversation partner. As another example, using a motion sensor, the device determines a speed of the user. When the user is moving quickly (e.g., having a conversation while driving a vehicle), the dimming value is higher or less likely to be reduced in response to detecting that the user is engaged in conversation with the conversation partner.

In various implementations, the dimming amount is determined based on user preferences. In various implementations, the user preferences are provided by the user via a user interface. In various implementations, the user preferences are generated based on user feedback. In various implementations, the user feedback includes actions taken to confirm or deny the automatic setting of the dimming value, such as selection of confirm affordances and/or deny affordances (as described with respect to FIG. 2B), manually setting the dimming value, or removing the device. For example, if the device does not dim the display in response to detecting that the user is engaged in conversation with the conversation partner, the user may remove the device to prevent shading of the user's eye rather than manually set the dimming value. In various implementations, the various factors (e.g., the confidence score and the data from the sensors) are provided to a machine-learning algorithm to determine the dimming amount. In various implementations, the machine-learning algorithm is further trained based on the user feedback. Thus, in various implementations, determining the dimming amount is further based on user preferences regarding dimming in response to detecting that the user is engaged in conversation with the conversation partner.

In various implementations, determining the dimming amount is based on a current dimming value of the dimming layer. For example, in FIG. 3D, in response to detecting that the user is engaged in conversation with the person 315, the dimming value is set to half of the current dimming value of one-half, e.g., set to one-quarter.

The method 400 continues, in block 430, with the device setting the dimming value of at least a portion of the dimming layer to the dimming amount. In various implementations, the device sets the dimming value of all of the dimming layer to the dimming amount. For example, in FIG. 2B, the dimming value of the entire display is set to zero. In various implementations, the device sets the dimming value of only a region of the dimming layer surrounding the conversation partner to the dimming amount. For example, in FIG. 3C, the dimming value of the region of the display surrounding the person 315 is set to zero. In various implementations, the device sets the dimming value of the dimming layer excluding a region surrounding virtual content. For example, in FIG. 2C, the dimming value of the display excluding the region 240 (and the adjacent feathering region) is set to zero.

In various implementations, setting the dimming value includes decreasing the dimming value from a current dimming value to the dimming amount. For example, in FIG. 2B, the dimming value is set from one-half to zero. Thus, in various implementations, setting the dimming value includes setting the dimming value to zero. As another example, in FIG. 3D, the dimming value is set from one-half to one-quarter.

In various implementations, the method includes, in response to setting the dimming value, displaying a dimming notification. For example, in FIG. 2B, the electronic device displays the dimming notification 224. In various implementations, setting the dimming value includes setting the dimming value from a current dimming value to the dimming amount and the dimming notification includes an affordance which, when selected, sets (or resets) the dimming value to the current dimming value. For example, in FIG. 2B, the electronic device displays the deny affordance 232.

By automatically setting the dimming value based on detecting that the user is engaged in conversation with a conversation partner, the user avoids cumbersome interaction to adjust the user's appearance to the conversation partner to avoid appearing rude or otherwise socially offensive.

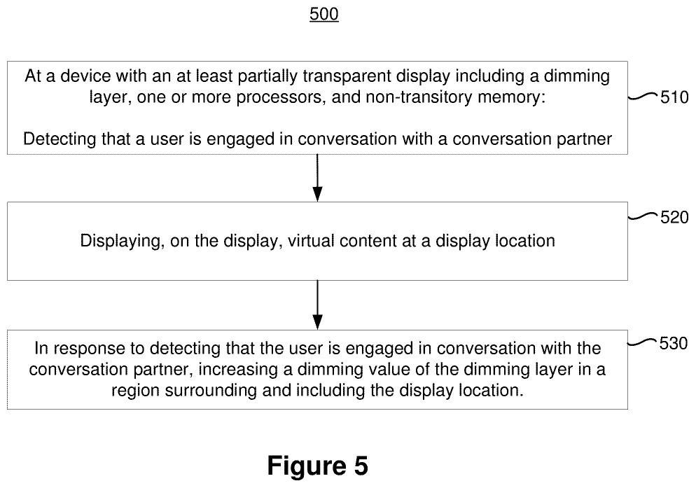

FIG. 5 is a flowchart representation of a method of setting a dimming value of a display in accordance with some implementations. In various implementations, the method 500 is performed by a device with an at least partially transparent display including a dimming layer, one or more processors, and non-transitory memory (e.g., the HMD 120 of FIG. 1). In some implementations, the method 500 is performed by processing logic, including hardware, firmware, software, or a combination thereof. In some implementations, the method 500 is performed by a processor executing instructions (e.g., code) stored in a non-transitory computer-readable medium (e.g., a memory).

The method 500 begins, in block 510, with the device detecting that the user is engaged in conversation with a conversation partner. In various implementations, the device detects that the user is engaged in conversation with the conversation partner using input from various sensors of the device, such as a microphone, an image sensor, and an eye tracker. For example, in various implementations, the device detects that the user is engaged in conversation with the conversation partner based on speech detected by the microphone from the user to the conversation partner and/or from the conversation partner to the user. In various implementations, the device detects that the user is engaged in conversation with the conversation partner based on detecting the conversation partner in an image captured with the image sensor and based on detecting that the user is looking at the conversation partner based on eye tracking data from the eye tracker. In various implementations, the device detects that the user is engaged in conversation based on an amount of time that speech and/or gaze being directed towards the conversation partner is detected, thereby discriminating between a conversation and a brief message (e.g., “Excuse me.”).

In various implementations, the device determines, based on the data from the sensors, a confidence score indicative of a likelihood that the user is engaged in conversation with the conversation partner. In various implementations, the device detects that the user is engaged in conversation with the conversation partner when the confidence score is greater than a threshold score.

The method 500 continues, in block 520, with the device displaying, on the display, virtual content at a display location. In various implementations, the virtual content is based on the conversation. For example, in various implementations, the virtual content includes a transcription of the conversation or a translation of the conversation. For example, in FIG. 2C, the electronic device displays the transcription 225. In various implementations, the virtual content includes a notification. For example, in various implementations, the notification indicates a received text message, incoming phone call, alarm, or reminder. For example, in FIG. 3E, the electronic device displays the alarm notification 323.

The method 500 continues, in block 530, with the device, in response to detecting that the user is engaged in conversation with the conversation partner, increasing a dimming value of the dimming layer in a region surrounding and including the display location. For example, in FIG. 2C, the dimming value of the region 240 is increased from zero (during the second time period of FIG. 2B) to one-half. As another example, in FIG. 3E, the dimming value of the region 340 is increased from one-quarter (during the second time period of FIG. 3D) to three-quarters.

In various implementations, increasing the dimming value includes determining a dimming amount and setting the dimming value of the dimming layer in the region to the dimming amount. In various implementations, the dimming amount is a default dimming value (e.g., one). In various implementations, the dimming amount is based on a current dimming value of the region. In various implementations, the dimming amount is based on any of the factors described above with respect to FIG. 4.

In various implementations, the region extends to an edge of the dimming layer. In various implementations, the region includes the bottom of the dimming layer. In various implementations, the region includes the top of the dimming layer. In various implementations, the dimming value of the region decreases as a function of distance from the edge of the dimming layer. The function is not necessarily strictly decreasing. For example, in FIG. 3E, the dimming value of the region 340 is three-quarters and the dimming value of the adjacent region decreases as a function of distance from the bottom of the dimming layer until a value of one-quarter is reached.

In various implementations, increasing the dimming value is further performed in response to determining that a gaze of the user is directed to the display location. Thus, in various implementations, even when the device detects that the user is engaged in conversation with a conversation partner and virtual content is displayed, the dimming value is not increased until the user looks at the virtual content. Similarly, in various implementations, even when the device detects that virtual content is displayed and the user looks at the virtual content, the dimming value is not increased unless the device detects that the user is engaged in conversation with the conversation partner. Thus, in various implementations, the method 500 includes, in response to detecting that the user is not engaged in conversation with the conversation partner, forgoing increasing the dimming value.

In various implementations, the method 400 of FIG. 4 and the method 500 of FIG. 5 may be performed together. For example, in various implementations, after setting the dimming value (in block 430) to remove dimming in response to detecting that the user is engaged in conversation with the conversation partner, the device may display a notification or other virtual content (in block 520) and, since the user is engaged in conversation, dim (in block 530) the region surrounding the virtual content. For example, in FIG. 2B, in response to detecting that the user is engaged in conversation with the person 213, the electronic device automatically undims (and displays the dimming notification 224). Then, in FIG. 2C, in response to displaying the transcription 225, the electronic device dims the region 240.

By dimming the region surrounding and including the virtual content, the device provides a cue to a conversation partner to avoid misinterpretation of the aversion of the user's gaze from the conversation partner as being uninterested in the conversation or interested in a real object behind the virtual content. Further, by dimming the region surrounding and including the virtual content, the device provides enhanced contrast between the virtual content and the physical environment, enhancing readability or other forms of consumption.

FIG. 6 is a block diagram of an example of the controller 110 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the controller 110 includes one or more processing units 602 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 606, one or more communication interfaces 608 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 610, a memory 620, and one or more communication buses 604 for interconnecting these and various other components.

In some implementations, the one or more communication buses 604 include circuitry that interconnects and controls communications between system components. In some implementations, the one or more I/O devices 606 include at least one of a keyboard, a mouse, a touchpad, a joystick, one or more microphones, one or more speakers, one or more image sensors, one or more displays, and/or the like.

The memory 620 includes high-speed random-access memory, such as dynamic random-access memory (DRAM), static random-access memory (SRAM), double-data-rate random-access memory (DDR RAM), or other random-access solid-state memory devices. In some implementations, the memory 620 includes non-volatile memory, such as one or more magnetic disk storage devices, optical disk storage devices, flash memory devices, or other non-volatile solid-state storage devices. The memory 620 optionally includes one or more storage devices remotely located from the one or more processing units 602. The memory 620 comprises a non-transitory computer readable storage medium. In some implementations, the memory 620 or the non-transitory computer readable storage medium of the memory 620 stores the following programs, modules and data structures, or a subset thereof including an optional operating system 630 and an XR experience module 640.

The operating system 630 includes procedures for handling various basic system services and for performing hardware dependent tasks. In some implementations, the XR experience module 640 is configured to manage and coordinate one or more XR experiences for one or more users (e.g., a single XR experience for one or more users, or multiple XR experiences for respective groups of one or more users). To that end, in various implementations, the XR experience module 640 includes a data obtaining unit 642, a tracking unit 644, a coordination unit 646, and a data transmitting unit 648.

In some implementations, the data obtaining unit 642 is configured to obtain data (e.g., presentation data, interaction data, sensor data, location data, etc.) from at least the HMD 120 of FIG. 1. To that end, in various implementations, the data obtaining unit 642 includes instructions and/or logic therefor, and heuristics and metadata therefor.

In some implementations, the tracking unit 644 is configured to map the physical environment 105 and to track the position/location of at least the HMD 120 with respect to the physical environment 105 of FIG. 1. To that end, in various implementations, the tracking unit 644 includes instructions and/or logic therefor, and heuristics and metadata therefor.

In some implementations, the coordination unit 646 is configured to manage and coordinate the XR experience presented to the user by the HMD 120. To that end, in various implementations, the coordination unit 646 includes instructions and/or logic therefor, and heuristics and metadata therefor.

In some implementations, the data transmitting unit 648 is configured to transmit data (e.g., presentation data, location data, etc.) to at least the HMD 120. To that end, in various implementations, the data transmitting unit 648 includes instructions and/or logic therefor, and heuristics and metadata therefor.

Although the data obtaining unit 642, the tracking unit 644, the coordination unit 646, and the data transmitting unit 648 are shown as residing on a single device (e.g., the controller 110), it should be understood that in other implementations, any combination of the data obtaining unit 642, the tracking unit 644, the coordination unit 646, and the data transmitting unit 648 may be located in separate computing devices.

Moreover, FIG. 6 is intended more as functional description of the various features that may be present in a particular implementation as opposed to a structural schematic of the implementations described herein. As recognized by those of ordinary skill in the art, items shown separately could be combined and some items could be separated. For example, some functional modules shown separately in FIG. 6 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 7 is a block diagram of an example of the HMD 120 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the HMD 120 includes one or more processing units 702 (e.g., microprocessors, ASICs, FPGAs, GPUs, CPUs, processing cores, and/or the like), one or more input/output (I/O) devices and sensors 706, one or more communication interfaces 708 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 710, one or more XR displays 712, one or more optional interior- and/or exterior-facing image sensors 714, a memory 720, and one or more communication buses 704 for interconnecting these and various other components.

In some implementations, the one or more communication buses 704 include circuitry that interconnects and controls communications between system components. In some implementations, the one or more I/O devices and sensors 706 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more XR displays 712 are configured to provide the XR experience to the user. In some implementations, the one or more XR displays 712 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more XR displays 712 correspond to diffractive, reflective, polarized, holographic, etc. waveguide displays. For example, the HMD 120 includes a single XR display. In another example, the HMD 120 includes an XR display for each eye of the user. In some implementations, the one or more XR displays 712 are capable of presenting MR and VR content.

In some implementations, the one or more image sensors 714 are configured to obtain image data that corresponds to at least a portion of the face of the user that includes the eyes of the user (any may be referred to as an eye-tracking camera). In some implementations, the one or more image sensors 714 are configured to be forward-facing so as to obtain image data that corresponds to the physical environment as would be viewed by the user if the HMD 120 was not present (and may be referred to as a scene camera). The one or more optional image sensors 714 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 720 includes high-speed random-access memory, such as DRAM, SRAM, DDR RAM, or other random-access solid-state memory devices. In some implementations, the memory 720 includes non-volatile memory, such as one or more magnetic disk storage devices, optical disk storage devices, flash memory devices, or other non-volatile solid-state storage devices. The memory 720 optionally includes one or more storage devices remotely located from the one or more processing units 702. The memory 720 comprises a non-transitory computer readable storage medium. In some implementations, the memory 720 or the non-transitory computer readable storage medium of the memory 720 stores the following programs, modules and data structures, or a subset thereof including an optional operating system 730 and an XR presentation module 740.

The operating system 730 includes procedures for handling various basic system services and for performing hardware dependent tasks. In some implementations, the XR presentation module 740 is configured to present XR content to the user via the one or more XR displays 712. To that end, in various implementations, the XR presentation module 740 includes a data obtaining unit 742, a dimming unit 744, an XR presenting unit 746, and a data transmitting unit 748.

In some implementations, the data obtaining unit 742 is configured to obtain data (e.g., presentation data, interaction data, sensor data, location data, etc.) from at least the controller 110 of FIG. 1. To that end, in various implementations, the data obtaining unit 742 includes instructions and/or logic therefor, and heuristics and metadata therefor.

In some implementations, the dimming unit 744 is configured to set the dimming value of at least a portion of the one or more XR displays 712. To that end, in various implementations, the dimming unit 744 includes instructions and/or logic therefor, and heuristics and metadata therefor.

In some implementations, the XR presenting unit 746 is configured to display the transformed image via the one or more XR displays 712. To that end, in various implementations, the XR presenting unit 746 includes instructions and/or logic therefor, and heuristics and metadata therefor.

In some implementations, the data transmitting unit 748 is configured to transmit data (e.g., presentation data, location data, etc.) to at least the controller 110. In some implementations, the data transmitting unit 748 is configured to transmit authentication credentials to the electronic device. To that end, in various implementations, the data transmitting unit 748 includes instructions and/or logic therefor, and heuristics and metadata therefor.

Although the data obtaining unit 742, the dimming unit 744, the XR presenting unit 746, and the data transmitting unit 748 are shown as residing on a single device (e.g., the HMD 120), it should be understood that in other implementations, any combination of the data obtaining unit 742, the dimming unit 744, the XR presenting unit 746, and the data transmitting unit 748 may be located in separate computing devices.

Moreover, FIG. 7 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 7 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a device with an at least partially transparent display including a dimming layer, one or more processors, and non-transitory memory:
detecting that a user is engaged in conversation with a conversation partner;
determining a dimming amount based at least in part on detecting that the user is engaged in conversation with the conversation partner; and
setting a dimming value of at least a portion of the dimming layer to the dimming amount.

2. The method of claim 1, wherein determining the dimming amount is further based on factors based on data from one or more sensors.

3. The method of claim 2, wherein the one or more sensors include an ambient light sensor, a location sensor, an image sensor, an eye tracker, or a motion sensor.

4. The method of claim 1, wherein determining the dimming amount is further based on user preferences regarding dimming in response to detecting that the user is engaged in conversation with the conversation partner.

5. The method of claim 1, wherein determining the dimming amount is based on a current dimming value of the dimming layer.

6. The method of claim 1, wherein setting the dimming value includes setting the dimming value of all of the dimming layer to the dimming amount.

7. The method of claim 1, wherein setting the dimming value includes setting the dimming value of only a region of the dimming layer surrounding the conversation partner to the dimming amount.

8. The method of claim 1, wherein setting the dimming value includes setting the dimming value of the dimming layer excluding a region surrounding virtual content.

9. The method of claim 1, wherein setting the dimming value includes decreasing the dimming value from a current dimming value to the dimming amount.

10. The method of claim 1, wherein setting the dimming value includes setting the dimming value to zero.

11. The method of claim 1, further comprising:
in response to setting the dimming value, displaying a dimming notification.

12. The method of claim 11, wherein setting the dimming value includes setting the dimming value to the dimming amount from a current dimming value to the dimming amount, wherein the dimming notification includes an affordance which, when selected, sets the dimming value to the current dimming value.

13. A device comprising:
an at least partially transparent display including a dimming layer;
non-transitory memory; and
one or more processors to:
detect that a user is engaged in conversation with a conversation partner;
determine a dimming amount based at least in part on detecting that the user is engaged in conversation with the conversation partner; and
set a dimming value of at least a portion of the dimming layer to the dimming amount.

14. The device of claim 13, wherein the one or more processors are to determine the dimming amount based on factors based on data from one or more sensors.

15. The device of claim 14, wherein the one or more sensors include an ambient light sensor, a location sensor, an image sensor, an eye tracker, or a motion sensor.

16. The device of claim 13, wherein the one or more processors are to set the dimming value by setting the dimming value of all of the dimming layer to the dimming amount.

17. The device of claim 13, wherein the one or more processors are to set the dimming value by setting the dimming value of only a region of the dimming layer surrounding the conversation partner to the dimming amount.

18. The device of claim 13, wherein the one or more processors are to set the dimming value by setting the dimming value of the dimming layer excluding a region surrounding virtual content.

19. The device of claim 13, wherein the one or more processors are to set the dimming value by setting the dimming value to zero.

20. A non-transitory memory storing one or more programs, which, when executed by one or more processors of a device including an at least partially transparent display including a dimming layer, cause the device to:
detect that a user is engaged in conversation with a conversation partner;
determine a dimming amount based at least in part on detecting that the user is engaged in conversation with the conversation partner; and
set a dimming value of at least a portion of the dimming layer to the dimming amount.
